(19) United States
(12) Patent Application Publication
(10) Pub. No.: US 2026/0297857 A1
(43) Pub. Date: Oct. 1, 2026

(54) METHOD AND APPARATUS FOR DETERMINING THE CONDITION OF A TRACK BED BY MEANS OF A TAMPING ASSEMBLY

(71) Applicant: PLASSER & THEURER EXPORT VON BAHNBAUMASCHINEN GESELLSCHAFT M.B.H., Wien (AT)

(72) Inventors: Christian KOCZWARA, Gresten (AT); Harald DAXBERGER, Linz (AT)

(21) Appl. No.: 19/478,943

(22) PCT Filed: Apr. 22, 2024
(86) PCT No.: PCT/EP2024/060914

§ 371 Date: Oct. 27, 2025

(30) Foreign Application Priority Data
Apr. 27, 2023 (AT) A50315/2023

(51) Int. Cl. E01B 35/00; E01B 27/16; G01N 3/48; G01S 13/88

(52) U.S. Cl. CPC E01B 35/00; E01B 27/16; G01N 3/48; G01S 13/885; G01N 2203/0048

(57) ABSTRACT

A method for determining the condition, in particular the quality, of a track bed by way of a tamping assembly includes the following steps: moving the tamping assembly relative to the track bed between a retracted position, in which at least one compaction tool of the tamping assembly is situated outside the track bed, and a penetrating position, in which the at least one compaction tool penetrates into the track bed; detecting measured values of at least one measurement variable, which correlates with a vertical reaction force acting between the tamping assembly and the track bed, at different measurement times; and determining the condition of the track bed on the basis of at least two of the measured values detected at different measurement times. There is also described an apparatus for carrying out the method.

The invention relates to a method for determining the condition, in particular the quality condition, of a track bed by means of a tamping unit. The invention further relates to a device for determining the condition, in particular the quality condition, of a track bed by means of a tamping unit.

A method and a device for compacting a track bed are known from AT 520056A1. A force transmitted to the track ballast as a result of a horizontal vibrating movement of tamping tools is recorded in order to draw conclusions about the condition of the track bed therefrom. The results obtained here are not always sufficient for a precise determination of the condition of the track bed. There is an ongoing need to determine the condition of a track ballast bed in a particularly reliable, precise, and cost-efficient manner.

It is an object of the invention to create an improved method for determining the condition, in particular the quality condition, of a track bed, which is in particular particularly precise, reliable, and cost-efficient in operation.

This object is achieved by way of a method with the features of claim 1. It was recognized that the condition, in particular a quality condition, of a track bed can be determined on the basis of measured values of a measurand, which correlates with a vertical reaction force acting between a tamping unit and the track bed. In particular, it was found that the vertical reaction force, in particular a measurand correlating therewith, allows particularly precise conclusions about the condition of the track bed, in particular about the properties essential for the operation of the track. This can be explained by the fact that the vertical reaction force between the tamping unit and the track bed is particularly close to the essential loads on the track bed during operation, especially when rail vehicles are travelling on it. There is a close relation between the measurand correlating with the vertical reaction force and the condition of the track bed, in particular those properties of the track bed that are particularly decisive for the safe operation of the track. As the condition of the track bed is determined when the tamping unit is displaced, the condition can also be determined during the compacting or tamping process. Separate measuring runs can be refrained from. The method is therefore particularly precise, reliable, and economical in operation.

Preferably, the condition is determined when the tamping unit is displaced relative to the track bed between a return position, in which at least one compacting tool of the tamping unit is arranged outside the track bed, and a penetration position, in which the at least one compacting tool penetrates the track bed.

Preferably, the condition of the track bed is determined using at least two measured values recorded at different measuring times, in particular the same measurand.

The condition of the track bed is preferably understood to mean at least one property decisive for the operation of the track. Decisive are in particular the properties relating to the load-carrying capacity, stiffness, and/or damping properties of the track bed. Information on the condition of the track bed may comprise information on the quality condition of the track bed, in particular on a grain size, fines, a degree of compaction, a degree of fouling, in particular a degree of vegetation, and/or on a ballast bed stiffness. The condition may also comprise information on the layer thickness of the track ballast, in particular a filling height relative to a track sleeper underside.

The track bed is a track bed that can be treated with a tamping unit. The track bed is also called a track ballast bed.

Preferably, at least one condition key figure, in particular at least one quality key figure, is determined on the basis of the at least two measured values recorded at the different measuring times. The condition key figure can correlate with an energy required to displace the at least one compacting tool into the track bed, in particular to the maximum penetration depth. The penetration energy can be determined as the integral of a vertical driving force, which acts on the at least one compacting tool, over the displacement, in particular the vertical displacement, which the compacting tool travels in the track bed. The quotient of the penetration energy and the maximum penetration depth provides a particularly meaningful condition key figure. The resulting condition key figure is therefore largely independent of the penetration depth of the compacting tools.

Preferably, the plurality of condition key figures is weighted in relation to one another and summarized into a single resulting condition key figure, which indicates the condition of the track bed particularly meaningfully.

The at least one tamping unit can have at least one, in particular at least two, in particular at least four, in particular at least eight, compacting tools. Preferably, the tamping unit comprises a plurality of compacting tools arranged in pairs, in particular those that can be squeezed towards each other.

The compacting tool is also called a compacting tool. The at least one compacting tool is preferably a tamping tine.

The condition of the track bed can be determined on the basis of the at least two measured values of the same measurand recorded at different measuring times. Preferably, the condition is determined on the basis of at least two, in particular at least three, in particular at least 10, in particular at least 20, in particular at least 50, in particular at least 100, and/or at most 1,000 measured values, in particular of the same measurand.

The measured values of the at least one measurand are preferably recorded with sensors. The at least one sensor for recording the measured values can be a force sensor, and/or a pressure sensor, and/or a displacement sensor, and/or a rotary transducer, and/or a tension sensor, and/or an ammeter, and/or a flow sensor, and/or a power sensor. The at least one sensor can be a component of the tamping unit, in particular of a system for controlling and/or regulating the tamping unit.

By means of the at least one force sensor, for example, a measured value in the form of a vertical driving force can be recorded, which causes the at least one compacting tool to penetrate the track bed. This vertical driving force correlates accordingly with the vertical reaction force between the tamping unit and the track bed.

Alternatively or additionally, a vertical position of the at least one compacting tool can be recorded by means of the at least one displacement sensor to determine the measured values. This measurand also correlates with the vertical reaction force between the tamping unit and the track bed, as for different conditions, in particular stiffnesses, of the track bed, in particular with a constant vertical driving force, different vertical velocities of the at least one compacting tool result, with corresponding effects on the time course of the vertical position of the at least one compacting tool.

The at least two measured values, in particular all measured values and/or successive measured values, are preferably recorded at a time interval of at least 0.001 s, in particular at least 0.01 s, in particular at least 0.1 s, in particular at least 1 s, and/or at most 1 h, in particular at most 60 s, in particular at most 10 s, in particular at most 1 s, in particular at most 0.1 s. This advantageously ensures that the recorded measured values make the determination of the condition of the track bed with a high temporal and/or local resolution possible. Preferably, at least two, in particular consecutive or non-consecutive, of the measured values are recorded at a time interval of at least 2 s, in particular at least 10 s, in particular at least 20 s, in particular at least 60 s, in particular at least 5 min, in particular at least 30 min, in particular at least 60 min and/or at most 24 h, in particular at most 12 h.

The vertical reaction force is understood to mean a force that is predominantly, in particular exclusively, vertically orientated. Preferably, the measurand correlates with a vertical component of a resulting reaction force between the tamping unit and the track bed. To determine the condition of the track bed, additional measured values of at least one additional measurand can be taken into account, which correlates with a horizontal reaction force acting between the tamping unit and the track bed.

A method according to claim 2 ensures the determination of the condition of the track bed in a particularly reliable and efficient manner. The determination of the condition of the track bed can be carried out by determining the penetration force, in particular a maximum penetration force, which is determined, in particular on the basis of a time course, of the vertical driving force that is applied to the at least one compacting tool for penetrating the track bed. The penetration force can be determined on the basis of the vertical driving force, in particular correspond to one another identically. More preferably, the penetration force is determined on the basis of the vertical driving force and taking into account, in particular minus, the inertial force as a result of the vertical acceleration of the at least one compacting tool, in particular all masses of the tamping unit moved by the vertical driving force, in particular all masses moved vertically together with a tamping unit frame of the tamping unit. The vertical acceleration can be determined, for example, on the at least one compacting tool and/or on the tamping unit frame. Preferably, the vertical acceleration is determined by means of a displacement sensor and/or an acceleration sensor. The vertical acceleration is also referred to as penetration acceleration. The masses to be used as a basis for determining the inertial force can be determined using the existing configuration of the tamping unit. Taking into account the mass inertia of the at least one compacting unit, the penetration force can be determined particularly precisely.

The maximum penetration force is preferably determined per tamping cycle, in particular per lowering movement of the at least one compacting tool. The vertical driving force can be recorded by means of a force sensor and/or a pressure sensor, in particular in a hydraulic vertical drive. The penetration velocity is preferably determined by means of a displacement sensor for recording a vertical position of the at least one compacting tool. The penetration velocity is also referred to as vertical velocity. The penetration work can be determined using the penetration force and the vertical position, in particular using the integral of the penetration force over the vertical position.

The parameters described above can be recorded directly as a measurand or determined on the basis of measured values of another measurand.

A tamping cycle is understood to mean that the at least one compacting tool is lowered into the track bed, in particular from the return position into the penetration position, that a squeezing movement of the at least one compacting tool takes place, in particular of at least two compacting tools arranged in pairs towards each other, and that the at least one compacting tool is lifted, in particular from the penetration position into the return position. To the at least one compacting tool a vibrating movement can be applied in addition, in particular during penetration of the track bed and/or during the squeezing movement. This promotes the desired redistribution of the track ballast and facilitates the penetration of the track bed by the tamping tools.

A method according to claim 3 ensures the particularly precise and reliable determination of the condition of the track bed. Preferably, the quotient is determined from the maximum penetration force, in particular per tamping cycle, and the penetration velocity, in particular at the vertical position of the maximum penetration force. This quotient is also known as the ballast penetration coefficient. The ballast penetration coefficient is a condition key figure which describes the condition of the track bed in a way which is particularly generally valid and particularly meaningful for the decisive properties of the track bed.

According to one aspect of the invention, a normalized ballast penetration coefficient is determined as a quotient of the ballast penetration coefficient and a maximum penetration depth of the at least one compacting tool into the track bed for determining the condition of the track bed. Other condition key figures are, for example, the penetration work and/or the quotient of the penetration work and the maximum penetration depth. Preferably, a correction, in particular a normalization, of the at least one condition key figure is carried out by the local track lift, in particular as a result of the penetration process. The vertical track lift is preferably understood to mean the vertical change in position of the track panel in the area treated, in particular the vertical change in position of that track sleeper at which the at least one compacting tool penetrates the track bed.

A method according to claim 4 ensures the condition of the track bed is determined in a particularly reliable manner. The condition of the track bed is preferably determined on the basis of at least three, in particular at least five, in particular at least 10, in particular at least 20, in particular at least 50, in particular at least 100, and/or at most 1,000 measured values of the measurand, in particular the same measurand, recorded at different measuring times. In other words, the determination of the condition of the track bed is carried out on the basis of a time course of the recorded measurand. For example, penetration values, in particular minima and/or maxima, and/or a time derivative, and/or a time integral of the measured values can be determined from the time course. The maximum penetration force, and/or the penetration velocity, and/or the penetration acceleration can be determined on the basis of the time course.

A method according to claim 5 ensures the determination of the condition of the track bed is carried out in a particularly reliable manner. Preferably, the measured values are determined in at least two, in particular at least three, in particular at least five, in particular at least 10, in particular at least 20, in particular at least 100, and/or at most 500, tamping cycles. In each tamping cycle, preferably a plurality of measured values are determined, in particular the time course of the measurand. Preferably, the plurality of tamping cycles is carried out at respectively adjacent track sleepers. The determination of the condition of the track bed can thus be carried out with a high local resolution. The condition can also be determined further over an area, comprising a plurality of track sleepers along the longitudinal direction of the rail, whereby the reliability of the measured values and/or the condition can be determined, in particular whereby measuring errors can be recognized as outliers in a view over a larger area along the longitudinal direction of the rail.

A method according to claim 6 ensures the particularly precise determination of the condition of the track bed. The at least two different measurands preferably correlate with the vertical driving force exerted on the at least one compacting tool and/or with the vertical position of the at least one compacting tool.

According to one aspect of the invention, the determination of the condition of the track bed is carried out on the basis of measured values of at least two identical measurands, which are, however, recorded at different measuring positions, in particular on different tamping units. The measured values of the same measurands can, for example, be recorded on at least two, in particular at least three, in particular at least four, of the tamping units. The at least two tamping units are preferably arranged at a distance from each other along a horizontal transverse direction of the rail. This allows the condition of the track bed to be individually determined for different positions along the horizontal transverse direction of the rail. Local contaminations of the track bed, for example on just one side of the track, can thus be identified.

A method according to claim 7 ensures the determination of the condition of the track bed is carried out with a particularly high meaningfulness. The at least one tamping unit is preferably operated by means of a control device for controlling and/or regulating the movement of the at least one compacting tool. The movement of the at least one compacting tool relative to the track is preferably carried out using specific control and/or regulation variables. If, for example, there is a track bed with a very high penetration resistance, in particular a high ballast stiffness, the vertical driving force and/or the vibration frequency transmitted to the at least one compacting tool and/or the vibration amplitude can be changed, in particular increased, by means of the control device. However, this can have an influence on the measured values used to determine the condition of the track bed. Corresponding control and/or regulation parameters are therefore preferably taken into account when determining the condition of the track bed. Preferably, the influence of changing control and/or regulation parameters on the respective condition key figure is compensated for, for example by normalizing the condition key figure with corresponding control and/or regulation parameters. Corresponding control and/or regulation parameters can comprise a regulation deviation, in particular a maximum regulation error, and/or integrated regulation deviations, in particular an integral regulation error weighted with the penetration depth, and/or an integral regulation error weighted with the regulator output, and/or a regulator output, in particular a maximum regulator output, and/or the actuating variable, in particular an actuating variable of the regulator averaged over the penetration depth.

A method according to claim 8 ensures the condition of the track bed is determined in a particularly reliable and precise manner. For example, to determine the condition of the track bed, a mean value and/or a scatter range of the measured values recorded and/or the condition determined can be evaluated, in particular over time and/or over the position at which the measured values are determined, in particular in the longitudinal direction of the rail and/or in a horizontal transverse direction of the rail. The evaluation can be carried out at a single measuring position, in particular for a specific horizontal arrangement of the tamping unit, in particular at a specific track sleeper. The statistical evaluation is preferably carried out using different positions of the at least one tamping unit, in particular in a horizontal direction, in particular at a plurality of track sleepers. This makes it possible to determine whether there is a special condition of the track bed at only a single measuring position, for example. This can be used, for example, to draw conclusions about a measuring error and/or a special local condition of the track bed.

According to one aspect of the invention, the statistical evaluation of the measured values comprises methods of artificial intelligence, in particular machine learning.

A method according to claim 9 ensures the determination of the condition of the track bed in a particularly precise and reliable manner. The variance and/or the standard deviation of the measured values at a single and/or at a plurality of, in particular adjacent, measuring positions correlates with the condition of the track bed. A high variance and/or standard deviation typically correlates with a less good condition of the track bed. The variance and/or standard deviation can be used to draw particularly reliable conclusions about the condition, in particular the quality condition of the track bed.

A method according to claim 10 ensures the determination of the condition of the track bed in a particularly precise and reliable manner. The georadar data can, be recorded with the recording of the measured values and/or taken from a data memory, in particular overlapping in time. Preferably the key values derived from the georadar data are compared with condition key figures determined on the basis of the measured values. Discrepancies, in particular as a result of measuring errors, can be recognized. This means that the determination of the condition of the track bed can be carried out particularly precisely and with high reliability.

A method according to claim 11 is particularly economical. Preferably, the measured values are recorded overlapping in time in the respective tamping cycle, in particular during penetration of the track bed by the compacting tools. This means that the determination of the condition of the track bed can be carried out at the same time as the track bed compaction.

In particular, the method can be used to merge information on the condition of the track bed from a plurality of sections of track into a common database. This can be used to generate a track-wide data set relating to the track bed condition. For example, maintenance measures can be initiated on the basis of a corresponding data set, in particular using artificial intelligence methods, in particular machine learning.

The invention also relates to a method for compacting a track bed by means of at least one tamping unit, in which the condition, in particular the quality condition, of the track bed is determined, in particular overlapping in time, in particular using the method described above.

A method according to claim 12 is particularly efficient and economical. Controlling the at least one track treatment step, in particular the track bed compaction, in particular the respective tamping cycle, is preferably carried out on the basis of the condition determined, in particular the quality condition, of the track bed. This allows the scope of the track treatment to be limited to the required extent and/or continued until a minimum desired condition is achieved. For example, if the condition of the track bed is insufficient, a plurality of tamping cycles can be carried out until the desired condition is achieved and/or until a termination criterion, for example a maximum number of tamping cycles, is reached.

Controlling the at least one track treatment step can comprise controlling the tamping process, and/or positioning, and/or aligning, and/or stabilizing the track.

A method according to claim 13 ensures the determination of the condition of the track bed in a particularly precise manner, in particular with a particularly high local resolution. Preferably, the determination of the condition of the track bed is carried out for at least one, in particular at least two, in particular at least three, in particular at least four, in particular at least six, in particular at least eight specific positions along a horizontal and/or vertical transverse direction of the track. The condition can be recorded along the horizontal transverse direction of the track by means of a plurality of tamping units. The condition of the track bed can be determined along the vertical transverse direction of the track for at least one specific penetration depth, in particular for different penetration depths, in particular for different layers of the track bed. This makes it possible to precisely identify a locally insufficient condition of the track bed. Maintenance efforts can be reduced to the minimum extent required.

Preferably, the track bed is classified on the basis of the condition determined, in particular in at least two, in particular at least three, condition categories. For example, a 3-stage traffic light model can be used, in which the condition of the track bed is categorized as good, sufficient, or insufficient.

According to one aspect of the invention, the measured values are used to determine a ballast level, in particular relative to a track sleeper, in particular to the underside of the track sleeper. Depending on the recorded ballast level, new ballast can be applied or the arrangement of the track panel on the track ballast can be adapted.

A further object of the invention is to create an improved device for determining the condition, in particular the quality condition, of a track bed, which, in particular, is particularly precise, reliable, and economical in operation.

This object is achieved by way of a device with the features of claim 14. The advantages of the device correspond to the advantages of the method described above. The device can be further developed with at least one of the features described above in connection with the method. The evaluation device is preferably designed to process digital data. This can comprise a processor, in particular a microcontroller. The evaluation device has a signal-transmitting connection with the measuring device. The evaluation device can have a signal connection to a control device for controlling the at least one tamping unit, in particular a control device of a track tamping machine.

The measuring device preferably has at least one of the aforementioned sensors, in particular a force sensor, and/or a pressure sensor, and/or a displacement sensor, and/or an acceleration sensor, for recording the measured values of the at least one measurand that correlates with the vertical reaction force between the tamping unit and the track bed.

A device according to claim 15 is particularly economical in operation. The device is preferably a track construction and maintenance machine, in particular a track tamping machine. The driving trailer for travelling on the track rails preferably has a drive device with a traction motor for displacing the device along the track.

The device preferably has a lifting and/or lining unit for positioning and aligning the track panel relative to the track bed.

Further features, details, and advantages of the invention result from the following description of an embodiment based on the figures. The following figures show:

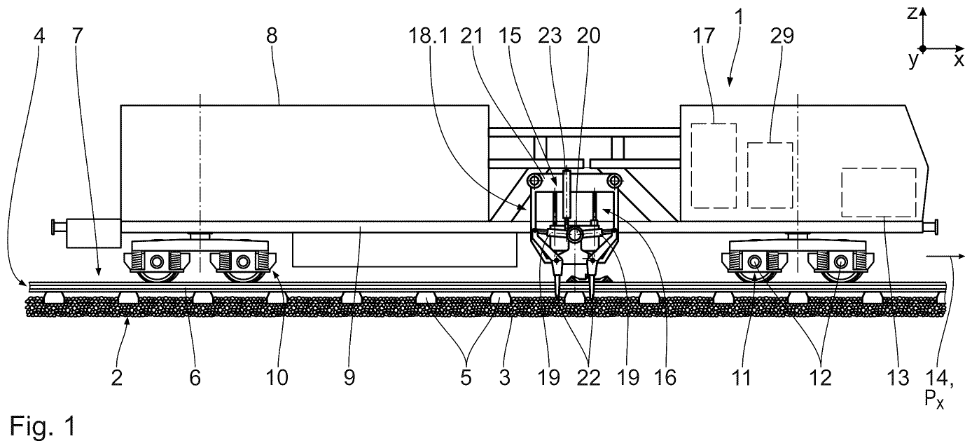

FIG. 1 a schematic representation of a track construction and maintenance machine with at least one device for determining the condition of a track bed and a tamping unit for compacting the track bed,

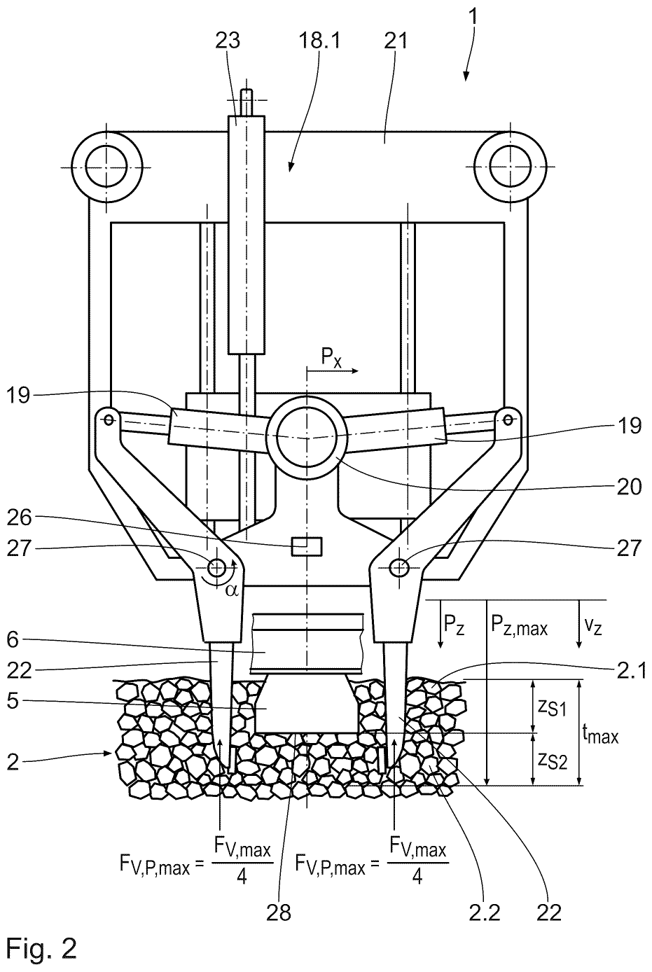

FIG. 2 a side view of the device in FIG. 1 in detail,

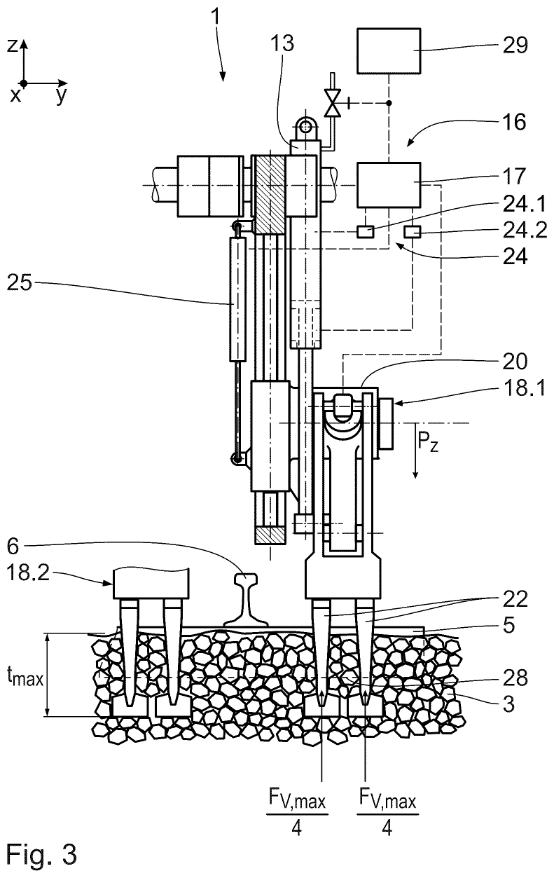

FIG. 3 a front view of the device in FIG. 1, with the tamping unit, a measuring device for recording measured values of at least one measurand, which correlates with the vertical reaction force acting between the tamping unit and the track bed, and an evaluation device for determining the condition of the track bed on the basis of the measured values.

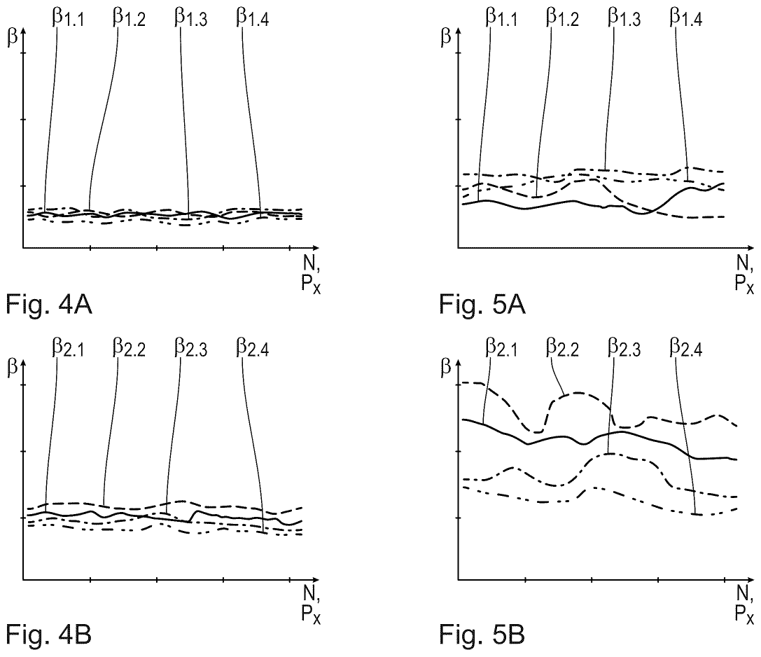

FIG. 4A a schematic representation of a curve of a condition key figure over the number of successively treated tamping positions with a good condition of the track bed, with the respective condition key figures being determined on the basis of measured values that are recorded at a penetration depth of a compacting tool in an area above a lower edge of a track sleeper,

FIG. 4B a schematic representation of the curve in FIG. 4A, with the respective condition key figure being determined on the basis of measured values that are recorded at a penetration depth of the compacting tool in an area below the lower edge of the track sleeper,

FIG. 5A a schematic representation of the curve in FIG. 4A with an insufficient condition of the track bed,

FIG. 5B a schematic representation of the curve in FIG. 4B with an insufficient condition of the track bed, or

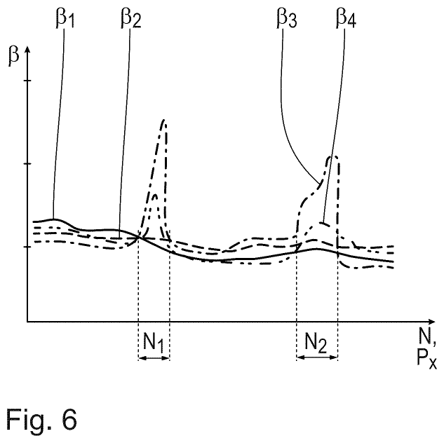

FIG. 6 a schematic representation of the curve in FIG. 4A with a predominantly good condition of the track bed, which is insufficient solely in two short sections along the longitudinal direction of the rail and on one side in the transverse direction of the rail.

With reference to FIGS. 1 to 6, an embodiment of a method or a device 1 for determining the condition of a track bed 2 is described.

The track bed 2 has track ballast 3, in particular it consists thereof. A track 4 is arranged on the track bed 2. The track 4 comprises track sleepers 5 and track rails 6, in particular it consists thereof. The combination of track sleepers 5 and track rails 6 is also known as a track panel. The track bed 2 and the track 4 together form the track superstructure 7.

The device 1 has a driving trailer 8 for travelling on the track rails 6. The driving trailer 8 is designed with a support structure 9 and a running gear 10 arranged thereon. The driving trailer 8 has a drive device 11 with at least one traction motor 12 and a drive control 13 for controlling the drive device 11. The driving trailer 8 is designed to displace the device 1 on the track 4, in particular in the longitudinal direction of the rail 14.

A Cartesian coordinate system is shown in FIG. 1. An x-direction points in the longitudinal direction of the track 14, in particular in the direction of travel. A z-direction points upwards in a vertical direction. A y-direction is orientated horizontally and perpendicularly to the longitudinal direction of the rail 14. The x-direction, the y-direction, and the z-direction form a right-handed system.

The device 1 has a track treatment device 15, a measuring device 16, and an evaluation device 17.

The track treatment device 15 is designed to treat the track 4, in particular the track bed 2. For this purpose, the track treatment device 15 comprises at least one tamping unit, in particular four tamping units 18.1, 18.2 for compacting the track bed 2. Two tamping units 18.1, 18.2 each are arranged at one of the track rails 6. FIG. 1 to FIG. 3 solely show the two tamping units 18.1, 18.2 arranged on the right in the direction of travel. The second tamping unit 18.2 shown in sections in FIG. 3 is preferably designed to correspond to the first tamping unit 18.1.

The at least one tamping unit 18.1, 18.2 has a squeezing drive 19 and a vibration drive 20. The squeezing drive 19 and the vibration drive 20 act between a tamping unit frame 21 and compacting tools 22, in particular tamping tines, which are designed to penetrate the track ballast 3.

The at least one tamping unit 18.1, 18.2 has a vertical drive 23, which acts between the support structure 9 and the compacting tools 22, in particular between the support structure 9 and the tamping unit frame 21. By means of the vertical drive 23, the compacting tools 22 can be displaced between a return position, in which the compacting tools 22 are arranged outside the track bed 2, and a penetration position, in which the compacting tools 22 are in engagement with the track bed 2. In the return position, the compacting tools 22 are arranged completely above the track sleepers 5, in particular completely above the track rails 6. In the penetration position, the compacting tools 22 are arranged vertically below the track sleepers 5, at least in sections.

The measuring device 16 has a force measuring means 24. The force measuring means 24 is designed to record a vertical driving force FV acting on the compacting tools 22 of the tamping unit 18.1, 18.2. The vertical driving force FV is provided by the vertical drive 23. The vertical driving force FV acts on the track bed 2 via the compacting tools 22. In particular, the vertical driving force FV corresponds to a vertical reaction force between the respective tamping unit 18.1, 18.2 and the track bed 2, in particular the track ballast 3. 1 The force measuring means 24 has a first pressure sensor 24.1 and a second pressure sensor 24.2. The pressure sensors 24.1, 24.2 each have a fluid-conducting connection to a pressure chamber of the vertical drive 23, designed as a hydraulic cylinder. The vertical driving force FV can be determined using the pressure difference recorded by the pressure sensors 24.1, 24.2.

The measuring device 16 has a displacement measuring means 25. The displacement measuring means 25 is designed to record a vertical position Pz of the at least one compacting tool 22. The vertical position Pz is the result of a displacing movement of the at least one compacting tool 22 during the displacement between the return position and the penetration position. The vertical position Pz therefore correlates with the vertical reaction force acting between the respective tamping unit 18.1, 18.2 and the track bed 2.

The measuring device 16 can have an acceleration sensor 26 for recording a vertical acceleration acting on the at least one compacting tool 22.

The measuring device 16 can have a rotary transducer 27. The rotary transducer 27 can be designed to record a squeezing movement of the at least one compacting tool 22, in particular the angle a about a squeezing pivot axis, in particular about a horizontal axis perpendicular to the longitudinal direction of the rail 14.

As an alternative or in addition to the force measuring means, the measuring device 16 can have a force measuring means, not shown, for recording a squeezing force caused by the squeezing drive 19, for example, a load cell.

The mode of operation of the method and of the device 1 for determining the quality of the track bed 2 by means of the at least one tamping unit 18.1, 18.2 is as follows:

The device 1 is arranged on the track 4. In particular, the driving trailer 8 is arranged on the track rails 6.

By means of the driving trailer 8, in particular the drive device 11, the device 1 is displaced to a section of track 4 to be treated.

The four tamping units 18.1, 18.2 are arranged along the longitudinal direction of the rail 14 in the area of the same sleeper 5, in particular in such a way that their compacting tools 22 are arranged at both sides of the same track sleeper 5. A tamping unit 18.1, 18.2 1 is arranged in the longitudinal direction of the rail 14 on both sides of the two track rails 6. The tamping units 18.1, 18.2 are situated in the return position, in particular completely above the track sleepers 5.

A first tamping cycle is carried out to treat the track bed 2, in particular to compact the track ballast 3. Each tamping cycle comprises at least lowering, squeezing, and lifting of the compacting tools 22.

Lowering of the compacting tools 22 is carried out by means of the vertical drive 23. The compacting tools 22 are lowered from the return position into the penetration position. In the penetration position, the compacting tools 22 are arranged below the respective track sleeper 5, at least in sections, in particular at a maximum penetration depth tmax relating to a surface of the track bed 2.

The squeezing of the squeezing tools 22 is carried out by means of the squeezing drive 19. In this, the compacting tools 22, each arranged in pairs, are moved towards each other, in particular in the direction of the track sleeper 5 gripped by the compacting tools 22, in particular pivoted.

The lifting of the compacting tools 22 from the penetration position to the return position is again carried out by means of the vertical drive 23.

Inside or outside the track ballast 3, the compacting tools 22 are pivoted back, in particular away from each other, by means of the squeezing drive 19. The first tamping cycle is now complete.

Preferably, a vibrating movement is applied to the compacting tools 22 at the lowering and/or during the squeezing movement. The vibration drive 20 serves to generate the vibrating movement. The vibrating movement is preferably transmitted to the compacting tools 22 via the squeezing drive 19.

The condition of the track bed 2, in particular the track ballast 3, has an influence on the vertical reaction force acting between the respective tamping unit 18.1, 18.2, in particular the compacting tools 22, and the track bed 2. Consequently, the recording of measured values of at least one measurand FV, Pz, which correlates with this vertical reaction force, allows conclusions to be drawn about the condition of the track bed 2.

The vertical driving force FV and the vertical position Pz are continuously recorded during the tamping cycle, in particular when the compacting tools 22 are lowered. The recording of corresponding measured values can be carried out at a frequency of 1 kHz. The continuously recorded measured values correspond to a time course of the respective measurand FV, Pz. During the lowering of the compacting tools 22, in particular at least 3, in particular at least 10, in particular at least 20, in particular at least 100, measured values are recorded, in particular within the same tamping cycle.

From the time course of the vertical driving force FV, in particular during the same tamping cycle, a, in particular global, maximum is determined, the maximum driving force FV,max. To determine the maximum driving force FV,max, at least three measured values for the same measurand are required, which are recorded at different measuring times.

This maximum driving force FV, max is divided by the number of compacting tools 22 displaced by the same vertical drive 23. This results in the maximum vertical driving force FV, P,max per compacting tool 22, in particular per tamping tine.

On the basis of the time course of the vertical position Pz, the associated vertical velocity vz of the compacting tools 22 can be determined for each vertical position Pz. The vertical position Pz,Fmax is determined, in which the maximum driving force FV,max is recorded. Then, the vertical velocity vz, Fmax of the compacting tools 22 at this vertical position Pz,Fmax is determined.

A particularly meaningful key figure for the condition of the track bed 2, namely a ballast penetration coefficient β, is determined as a quotient of the maximum driving force FV,P,max per compacting tool 22 and the associated vertical velocity vz,Fmax. Alternatively or additionally, the maximum vertical driving force FV, max, and/or the maximum vertical driving force FV,P,max per compacting tool 22, and/or a normalized ballast penetration coefficient, and/or a penetration work, and/or a quotient from the penetration work and the maximum penetration depth tmax, and/or from the vertical position Pz,Fmax at the maximum driving force FV can be determined as condition key figures. The penetration force can be determined to be identical to the vertical driving force FV. Preferably, the penetration force is determined from the vertical driving force FV reduced by the inertial force acting on the at least one compacting tool 22 as a result of vertical acceleration. The normalized ballast penetration coefficient is understood to mean the quotient of the ballast penetration coefficient β and a maximum penetration depth tmax. In addition, a correction factor can be applied to the at least one condition key figure, in particular to the normalized ballast penetration coefficient, which takes into account the influence of the track lift. Penetration work is understood to mean the integral of the vertical driving force FV over the vertical position Pz.

By means of the driving trailer 8, the device 1 is displaced to the nearest track sleeper 5, in particular in the longitudinal direction of the rail 4. There, the at least one tamping cycle is carried out repeatedly.

The ballast penetration coefficient β is preferably determined for each tamping cycle and for each of the four tamping units 18.1, 18.2. For each tamping position Px along the longitudinal direction of the rail 14, in particular at each track sleeper 5, at least one ballast penetration coefficient β is thus determined for each tamping unit 18.1, 18.2. This means that at position Px there are four ballast penetration coefficients β1, β2, β3, β4, in particular at both track rails 6, respectively inside and outside.

In principle, a plurality of tamping cycles can be carried out at the same track sleeper 5, in particular at the same position Px. This means that a plurality of ballast penetration coefficients β can be determined at the same track sleeper 5.

The at least one condition key figure is determined by means of the evaluation device 17. For this purpose, the evaluation device 17 can have a signal processing means, in particular for processing digital information. Preferably, the evaluation device 17 comprises a processor, in particular a microcontroller, for this purpose.

According to one particular aspect, the at least one condition key figure, in particular the respective ballast penetration coefficient β, is determined for at least one, in particular for a plurality of, specific layers 2.1, 2.2 of the track bed 2. A layer 2.1, 2.2 of the track bed 2 extends over a specific vertical area zS1, zS2. The first layer 2.1 extends in an area above a track sleeper underside 28. The second layer 2.2 extends between the respective track sleeper underside 28 and the maximum penetration depth tmax of the compacting tools 22. By determining the respective ballast penetration coefficients β1, β2, β3, β4 for specific layers 2.1, 2.2 of the track bed 2, the ballast bed condition can be evaluated individually in different vertical positions Pz. For example, this allows conclusions to be drawn about fouling solely in an upper area, in particular in the first layer 2.1.

FIG. 4A to FIG. 5B show the ballast penetration coefficients β along a line section of track 4, in particular over a large number N of track sleepers 5.

FIG. 4A shows the ballast penetration coefficients β1.1, β1.2, 1.3, β1.4, which are deter-mined for the upper layer 2.1 of the track bed 2 along the treated section of track. FIG. 4B shows the ballast penetration coefficients β2.1, β2.2, β2.3, β2.4 of the lower layer 2.2 of the track bed 2 of this section of track. In this section of track, the condition of the track bed 2 is good, in particular the track ballast 3 is new.

The information shown in FIGS. 5A and 5B corresponds to the information shown in FIGS. 4A and 4B, with the ballast penetration coefficients β1.1, β1.2, β1.3, β1.4, β2.1, β2.2, β2.3, β2.4 being determined in another line section of the track 4. In this section of track, the condition of the track bed 2 is insufficient. For example, the track ballast 3 is heavily fouled, silted, overgrown, and/or worn.

As can be seen from FIGS. 4A to 5B, the condition of the track bed 2 cannot be deter-mined solely on the basis of the ballast penetration coefficients β. Preferably, a condition key figure is determined on the basis of a statistical evaluation of the measured values, in particular of the ballast penetration coefficients β. For example, a condition key figure can be determined as the variance and/or as the standard deviation of the individual ballast penetration coefficients β over the number N and/or as the scatter range of the plurality of ballast penetration coefficients β at the same position Px along the longitudinal direction of the rail 14, in particular at a specific track sleeper 5. The higher the ballast penetration coefficient β and/or the variance of the ballast penetration coefficient β and/or the standard deviation of the ballast penetration coefficient β and/or the scatter of the plurality of ballast penetration coefficients β, the worse the condition of the track bed 2 typically is.

FIG. 6 shows a further curve of ballast penetration coefficients β over a number N of adjacent track sleepers in a further line section of the track 4. The respective ballast penetration coefficient β is evaluated for the entire penetration depth tmax. In specific areas N1, N2 along the longitudinal direction of the rail 14, a single ballast penetration coefficient β3 of the ballast penetration coefficients β1, β2, β3, β4 determined for each tamping unit 18.1, 18.2 is strongly increased. From this it can be concluded that the condition of the track bed 2 is locally insufficient. For example, in a corresponding area along the longitudinal direction of the rail 14 and solely in the area of one of the track rails 6, there is an insufficient condition of the track bed 2, for example local fouling of the track ballast 3 and/or damage to the track bed 2, for example as a result of underwashing.

The determination of the condition of the track bed 2 can be carried out on the basis of the measured values described above and taking georadar data into account. This allows the condition of the track bed to be determined even more precisely.

The measured values are preferably analysed using known methods of artificial intelligence, in particular machine learning.

Preferably, the evaluation device 17 has a signal connection to a control device 29 for controlling the at least one tamping unit 18.1, 18.2. The control device 29 can be designed to implement the displacing movements of the compacting tools 22 in accordance with predetermined control and/or regulation parameters. In particular, the tamping movement, in particular the penetration movement, can be carried out using trajectory sequential regulation. In particular, deviations from target values can be compensated for with counter-controlling of the control device 29. Corresponding compensation information is preferably taken into account when determining the condition of the track bed 2. In particular, a regulation deviation, in particular a maximum regulation error, and/or an integral regulation deviation, and/or a differential regulation deviation, and/or a regulator output, and/or an averaged actuating variable can be taken into account when determining the condition of the track bed 2. When determining the condition of the track bed 2, for example, a dependent vibration frequency of the vibration drive can be taken into account. In this way, the influence of changing control and regulation variables on the measured values for determining the condition of the track bed 2 can be compensated for.

Furthermore, when determining the condition of the track bed 2, the squeezing force, in particular a squeezing pressure, and/or a holding force, in particular a holding pressure, and/or a squeezing position, in particular a signal from the rotary transducer 27, and/or a drive power, in particular of the vibration drive 20, can be taken into account.

The ballast bed 2 is preferably classified on the basis of the condition. For example, the classification can distinguish between three quality conditions, in particular good, sufficient, and insufficient, in particular according to a 3-stage traffic light model.

Preferably, at least one track treatment step, in particular track bed compaction, is controlled on the basis of the condition determined. For example, a section of track in which the track bed 2 is classified as insufficient or sufficient can be treated. In particular, the track ballast 3 can be compacted or replaced there. Depending on the condition deter-mined, the position and/or the alignment of the track 4 can be adjusted and/or the track 4 can be stabilized.

Preferably, the information on the condition of the track bed 2 is used for determining the necessity of maintenance measures on a line section of the track 4. For example, a track bed report can be created, in particular for a customer and/or an infrastructure man-ager. A decision on whether to carry out the maintenance measures can be made on the basis of the information on the condition of the track bed 2.

Preferably, the current compacting process, during which the condition of the track bed 2 is determined, is controlled on the basis of the condition determined.

The method described above enables a particularly precise determination of the condition of a track bed 2. The track bed 2 can therefore be maintained particularly economically and reliably. A track 4 maintained on the basis of such a method is particularly reliable and safe in operation. The advantages of the device 1 correspond to the advantages of the method.

1-15. (canceled)

16. A method for determining a condition of a track bed by way of a tamping unit, comprising the steps:
displacing the tamping unit relative to the track bed between a retraction position, in which at least one compacting tool of the tamping unit is arranged outside the track bed, and a penetration position, in which the at least one compacting tool penetrates into the track bed;
recording measured values of at least one measurand, which correlates with a vertical reaction force acting between the tamping unit and the track bed, at different measuring times; and
determining the condition of the track bed based on at least two of the measured values recorded at different measuring times.

17. The method according to claim 16, which comprises determining the condition of the track bed on a basis of the at least two measured values at least one of a maximum penetration force, a penetration velocity, a penetration acceleration, or a penetration work.

18. The method according to claim 17, which comprises determining the condition of the track bed by determining a ratio of the maximum penetration force and the penetration velocity.

19. The method according to according to claim 16, which comprises determining the condition of the track bed on a basis of at least three measured values of the measurand recorded at different measuring times.

20. The method according to according to claim 16, which comprises determining the condition of the track bed on a basis of measured values recorded in at least two different tamping cycles.

21. The method according to according to claim 16, which comprises determining the condition of the track bed on a basis of measured values of at least two different measurands.

22. The method according to according to claim 16, which comprises determining the condition of the track bed by way of control parameters and/or by way of regulation parameters for operating the tamping unit.

23. The method according to according to claim 16, which comprises determining the condition of the track bed by way of a statistical evaluation of the measured values.

24. The method according to according to claim 23, which comprises determining the condition of the track bed based on a variance of the measured values.

25. The method according to according to claim 16, which comprises determining the condition of the track bed on a basis of georadar data.

26. The method according to according to claim 16, which comprises determining the condition of the track bed overlapping in time with a tamping cycle carried out by the tamping unit.

27. The method according to claim 16, which comprises controlling at least one track treatment step on a basis of the condition of the track bed so determined.

28. The method according to claim 16, which comprises determining the condition of the track bed for at least one relative position along a transverse direction of the track.

29. The method according to claim 16, wherein the condition of the track bed to be determined is a quality of the track bed.

30. A device for determining a condition of a track bed, the device comprising:
a tamping unit for compacting the track bed with at least one compacting tool for penetrating the track bed;
a measuring device for recording measured values of at least one measurand, which correlates with a vertical reaction force acting between the tamping unit and the track bed, at different measuring times; and
an evaluation device for determining the condition of the track bed on a basis of at least two of the measured values recorded at different measuring times.

31. The device according to claim 30, wherein the condition of the track bed to be determined is a quality of the track bed.

32. The device according to claim 30, comprising a driving trailer for travelling on track rails.
